(19) United States
(12) Patent Application Publication
(10) Pub. No.: US 2012/0050947 A1
(43) Pub. Date: Mar. 1, 2012

(54) ENERGY STORAGE APPARATUS AND METHOD FOR MANUFACTURING THE SAME

(75) Inventors: Hak Kwan Kim, Gyeonggi-do (KR); Bae Kyun Kim, Gyeonggi-do (KR); Dong Hyeok Choi, Gyeonggi-do (KR); Hyun Chul Jung, Gyeonggi-do (KR)

(73) Assignee: SAMSUNG Electro-Mechanics Co., Ltd.

(21) Appl. No.: 13/222,280

(22) Filed: Aug. 31, 2011

(30) Foreign Application Priority Data
Aug. 31, 2010 (KR) 10-2010-0084818

(51) Int. Cl. H01G 9/155; H01G 9/15; H01G 7/00; H01G 9/00; B82Y 99/00; B82Y 30/00

(52) U.S. Cl. 361/502; 29/25.41; 361/500; 361/523; 977/762; 977/948

(57) ABSTRACT

Disclosed herein is an energy storage apparatus. The energy storage apparatus according to an exemplary embodiment of the present invention includes: a first electrode structure; a second electrode structure opposite to the first electrode structure; and an electrolyte positioned between the first electrode structure and the second electrode structure, wherein the first electrode structure includes: a first current collector having a rugged structure; and a first active material layer conformally covering the rugged structure.

### CROSS REFERENCE TO RELATED APPLICATION

This application claims the benefit of Korean Patent Application No. 10-2010-0084818, filed on Aug. 31, 2010, entitled “Energy Storage Apparatus And Method For Manufacturing The Same”, which is hereby incorporated by reference in its entirety into this application.

### BACKGROUND OF THE INVENTION

1. Technical Field

The present invention relates to an energy storage apparatus and a method for manufacturing the same, and more particularly, to an energy storage apparatus improving capacitance and electrical conductivity of an electrode, and a method for manufacturing the same.

2. Description of the Related Art

Among the next energy storage devices, a device called an ultra capacitor or a supercapacitor has been in the limelight due to a rapid charging/discharging rate, high stability, and environment-friendly characteristics. A general supercapacitor is configured of an electrode structure, a separator, an electrolyte solution, and the like. The supercapacitor is driven based on an electrochemical reaction mechanism that selectively absorbs carrier ions in the electrolyte solution to the electrode by applying power to the electrode structure. As representative supercapacitors, a lithium ion capacitor (LIC), an electric double layer capacitor (EDLC), a pseudocapacitor, a hybrid capacitor, and the like are currently used.

The lithium ion capacitor is a supercapacitor that uses a positive electrode made of activated carbons and a negative electrode made of graphite, and uses lithium ions as carrier ions. The electric double layer capacitor is a supercapacitor that uses an electrode made of activated carbon and uses an electric double layer charging as a reaction mechanism. The pseudocapacitor is a supercapacitor which uses a transition metal oxide or a conductive polymer as an electrode and uses pseudo-capacitance as a reaction mechanism. The hybrid capacitor is a supercapacitor that has intermediate characteristics between the electric double layer capacitor and the pseudocapacitor.

As a method for improving capacitance of the supercapacitor, a surface area of an electrode may be increased. To this end, various kinds of carbon materials having relatively large surface areas are used as an active material of an electrode. The carbon material includes micro pores therein, thereby making it possible to have an effect to increase the area thereof. However, it has been known that among micro pores of general carbon materials, valid pores contributing to an actual charging/discharging reaction mechanism are about 20%. Actually, an active material layer of an electrode is formed by coating a current collector with slurry prepared by mixing a conductive material, a binder, a solvent, and the like, such that an actual valid contact area between an electrode and an electrolyte solution cannot but be reduced by the amount the current collector is coated with the slurry. Therefore, there is a limit in increasing the valid contact area between the electrode and the electrolyte solution when a carbon material is used for the electrode as described above. As a result, there is also a limit in increasing capacitance of the energy storage apparatus.

In addition, most of the energy storage apparatuses use an electrolyte in a liquid state. Therefore, the energy storage apparatuses are applied with various techniques for completely sealing the electrolyte. However, in the energy storage apparatuses, an electrolyte may be leaked to the outside due to external impact or heat, or internal configurations thereof may be corroded due to the electrolyte.

### SUMMARY OF THE INVENTION

An object of the present invention is to provide an energy storage apparatus with improved capacitance.

Another object of the present invention is to provide an energy storage apparatus preventing an electrolyte from being leaked and corroded.

Another object of the present invention is to provide a method for manufacturing an energy storage apparatus with improved capacitance.

Another object of the present invention is to provide a method for manufacturing an energy storage apparatus preventing an electrolyte from being leaked and corroded.

According to an exemplary embodiment of the present invention, there is provided an energy storage apparatus, including: a first electrode structure; a second electrode structure opposite to the first electrode structure; and an electrolyte positioned between the first electrode structure and the second electrode structure, wherein the first electrode structure includes: a first current collector having a rugged structure; and a first active material layer conformally covering the rugged structure.

The first current collector may include a metal plate made of copper.

The first active material layer may include a lithium containing metal layer.

The second electrode structure may include: a second current collector; and a second active material layer formed on the second current collector, wherein the second current collector may include an aluminum foil, and the second active material layer may include at least any one of activated carbon, graphite, carbon aerogel, polyacrylonitrile (PAN), carbon nano fiber (CNF), activating carbon nano fiber (ACNF), and vapor grown carbon fiber (VGCF).

The electrolyte may be provided in a solid state.

The electrolyte may include at least any one of LiPF6, LiBF4, LiSbF6, LiAsF5, LiC104, LiN, CF3SO3, LiC, LiN(SO2CF3)2, LiN(SO2C2F5)2, LiC(SO2CF3)2, LiPF4(CF3)2, LiPF3(C2F5)3, LiPF3(CF3)3, LiPF5(iso-C3F7)3, LiPF5(iso-C3F7), (CF2)2(SO2)2NLi, and (CF2)3(SO2)2NLi.

The rugged structure may include at least any one of pillar-shaped projections and line-shaped trenches.

The first electrode structure may be a positive electrode of the energy storage apparatus, the second electrode structure may be a negative electrode of the energy storage apparatus, and the electrolyte may include lithium ions (Li⁺) for a charging reaction mechanism between the positive electrode and the negative electrode.

According to another exemplary embodiment of the present invention, there is provided a method for manufacturing an energy storage apparatus, including: preparing a first current collector having a rugged structure; forming a first active material layer conformally covering the rugged structure to manufacture a first electrode structure; forming a second active material layer on a second current collector to manufacture a second electrode structure; and forming an electrolyte between the first electrode structure and the second electrode structure.

The preparing the first current collector may include: preparing a metal frame formed with a ruggedness with a shape corresponding to the rugged structure; depositing a metal layer on the ruggedness of the metal frame; and separating the metal layer from the metal frame.

The depositing the metal layer may include forming an aluminum layer on the metal frame.

The depositing the metal layer may include performing a physical vapor deposition (PVD) on the metal frame.

The forming the first active material layer may include depositing a lithium containing metal layer on the rugged structure.

An aluminum foil may be used as the second current collector, and the second active material layer may include an active material made of a carbon material.

At least any one of activated carbon, graphite, carbon aerogel, polyacrylonitrile (PAN), carbon nano fiber (CNF), activating carbon nano fiber (ACNF), and vapor grown carbon fiber (VGCF) may be used as the carbon material.

The first electrode structure may be used as a positive electrode of the energy storage apparatus, and the second electrode structure may be used as a negative electrode of the energy storage apparatus.

The forming the electrolyte may include depositing an electrolyte in a solid state on at least any one of the first electrode structure and the second electrode structure.

The first active material layer may contain lithium, the electrolyte may include at least any one of LiPF6, LiBF4, LiSbF6, LiAsF5, LiClO4, LiN, CF3SO3, LiC, LiN(SO2CF3)2, LiN(SO2C2F5)2, LiC(SO2CF3)2, LiPF4(CF3)2, LiPF3(C2F5)3, LiPF3(CF3)3, LiPF5(iso-C3F7)3, LiPF5(iso-C3F7), (CF2)2(SO2)2NLi, and (CF2)3(SO2)2NLi, and the energy storage apparatus may be used as a lithium ion capacitor (LIC) using lithium ions (Li⁺) as carrier ions for a charging/discharging reaction mechanism.

### BRIEF DESCRIPTION OF THE DRAWINGS

FIG. 1 is a diagram showing an energy storage apparatus according to an exemplary embodiment of the present invention;

FIGS. 2 and 3 are diagrams for explaining a charging/discharging reaction mechanism of an energy storage apparatus according to an exemplary embodiment of the present invention;

FIG. 4 is a flow chart showing a method for manufacturing an energy storage apparatus according to an exemplary embodiment of the present invention; and

FIGS. 5 to 7 are diagrams for explaining a method for manufacturing an energy storage apparatus according to an exemplary embodiment of the present invention.

### DESCRIPTION OF THE PREFERRED EMBODIMENTS

Various advantages and features of the present invention and methods accomplishing thereof will become apparent from the following description of embodiments with reference to the accompanying drawings. However, the present invention may be modified in many different forms and it should not be limited to the embodiments set forth herein. These embodiments may be provided so that this disclosure will be thorough and complete, and will fully convey the scope of the invention to those skilled in the art. Like reference numerals in the drawings denote like elements.

Terms used in the present specification are for explaining the embodiments rather than limiting the present invention. Unless explicitly described to the contrary, a singular form includes a plural form in the present specification. The word “comprise” and variations such as “comprises” or “comprising,” will be understood to imply the inclusion of stated constituents, steps, operations and/or elements but not the exclusion of any other constituents, steps, operations and/or elements.

Hereinafter, an energy storage apparatus according to the present invention will be described in detail with reference to the accompanying drawings.

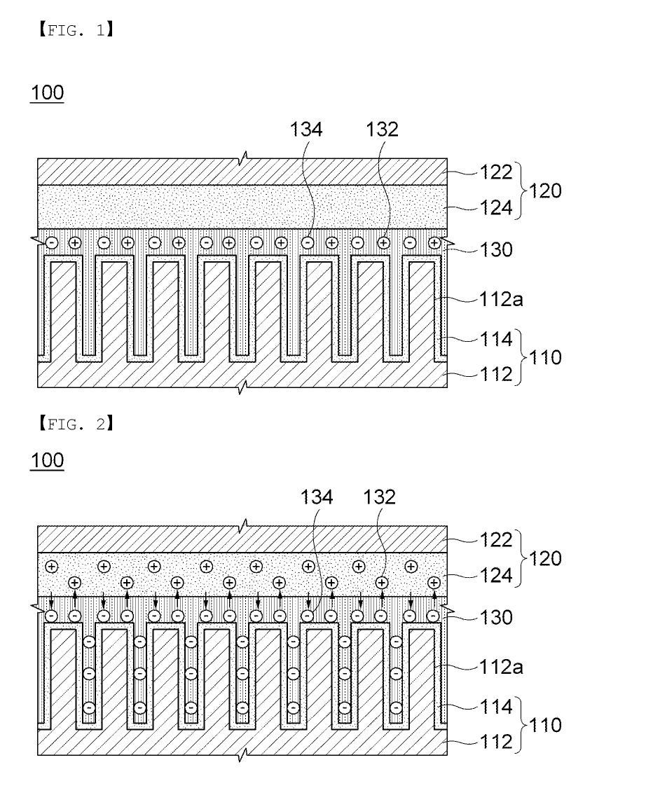

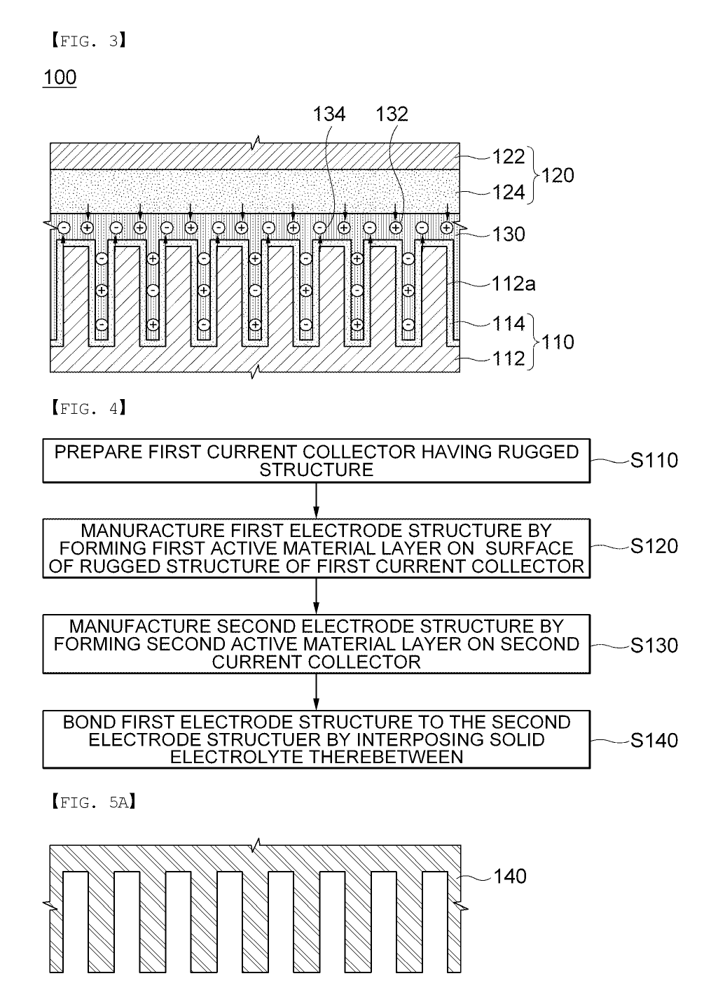

FIG. 1 is a diagram showing an energy storage apparatus according to an exemplary embodiment of the present invention. FIGS. 2 and 3 are diagrams for explaining a charging/discharging reaction mechanism of an energy storage apparatus according to an exemplary embodiment of the present invention.

Referring to FIG. 1, an energy storage apparatus 100 according to an exemplary embodiment of the present invention may include an electrode structure and a solid electrolyte 130.

The electrode structure may include a first electrode structure 110 and a second electrode structure 120. The first and second electrode structures 110 and 120 may be disposed in a case (not shown). Portions of the first and second electrode structures 110 and 120 may be configured to be selectively exposed to the outside of the case. The first electrode structure 110 and second electrode structure 120 may exchange carrier ions 132 and 134, which are electrochemical reaction mediators, through the electrolyte 130.

The first electrode structure 110 may include a first current collector 112 and a first active material layer 114 covering the surface of the first current collector 112.

A plate made of a metal material may be used as the first current collector 112. A copper plate may be used as the first current collector 112. Herein, the first current collector 112 may have a rugged structure 112a. The rugged structure 112a may include at least any one of pillar-shaped projections and trench-shaped lines. In this configuration, the widths of the projections and the lines may be in the range of several tens to several hundreds of nanometers. Therefore, an ultra-fine rugged structure 112a is formed on the surface of the first current collector 112, thereby making it possible to have a structure in which a contact area between the solid electrolytes 130 is increased.

The first active material layer 114 may be formed on the rugged structure 112a of the first current collector 112. The first active material layer 114 may be a predetermined lithium containing metal layer. In this configuration, the first active material layer 114 may be formed to conformally cover the rugged structure 112a. Therefore, the first active material layer 114 may be formed to have a uniform thickness on the surface of the rugged structure 112a.

The second electrode structure 120 may be formed to face the first electrode structure 110, having the solid electrolyte 130 therebetween. The second electrode structure 120 may include a second current collector 122 and a second active material layer 124 formed on the surface of the second current collector 122.

Various kinds of metal foils may be used as the second current collector 122. As an example, the second current collector 122 may include an aluminum foil. The second active material layer 124 may include various kinds of carbon materials. For example, the second active material layer 124 may include at least any one of activated carbon, graphite, carbon aerogel, polyacrylonitrile (PAN), carbon nano fiber (CNF), activating carbon nano fiber (ACNF), and vapor grown carbon fiber (VGCF). The second electrode structure 120 having the configuration as described may be used as a negative electrode of the energy storage apparatus 100.

The solid electrolyte 130, which has a solid state, may include positive ions 132 and negative ions 134, which are moving mediators between the first electrode structure 110 and the second electrode structure 120. The positive ions 132 may include lithium ions Li⁺. A lithium-based electrolyte may be used as the solid electrolyte 130. For example, the solid electrolyte 130 may include at least any one of LiPF6, LiBF4, LiSbF6, LiAsF5, LiClO4, LiN, CF3SO3, and LiC. Alternatively, the solid electrolyte 130 may include at least any one of LiN(SO2CF3)2, LiN(SO2C2F5)2, LiC(SO2CF3)2, LiPF4(CF3)2, LiPF3(C2F5)3, LiPF3(CF3)3, LiPF5(iso-C3F7)3, LiPF5(iso-C3F7), (CF2)2(SO2)2NLi, and (CF2)3(SO2)2NLi.

A charging operation and a discharging operation of the energy storage apparatus 100 having the configuration as described above may be performed based on the following mechanism.

Referring to FIG. 2, when a charging operation of the energy storage apparatus 100 starts, positive current may be applied to the first current collector 112 of the first electrode structure 110 and negative current may be applied to the second current collector 122 of the second electrode structure 120. Therefore, the positive ions 132 in the solid electrolyte 130 may be stored in the inside of the second active material layer 124 of the second electrode structure 120. To the contrary, the negative ions 134 may be absorbed to the first active material layer 114 of the first electrode structure 110.

Referring to FIG. 3, when the energy storage apparatus 100 is used, the positive ions 132 stored in the inside of the second active material layer 124 and the negative ions 134 absorbed to the first active material layer 114 are separate from the electrode structures 110 and 120, such that they may be moved to the solid electrolyte 130.

At the time of the charging/discharging operations as described above, the first electrode structure 110, which is used as a positive electrode of the energy storage apparatus 100, is configured of the first current collector 112 provided with the ultra-fine rugged structure 112a and the first active material layer 114 containing lithium conformally covering the rugged structure 112a, such that a valid reaction area between the solid electrolytes 130 may be increased. In particular, the first current collector 112 itself may be made of a metal plate and the first active material layer 114 may be provided as a lithium containing metal layer. Therefore, the first electrode structure 110 has remarkably high electrical conductivity as well as a structure containing a large amount of lithium ions, such that capacitance of the energy storage apparatus 100 can be significantly improved.

As described above, the energy storage apparatus 100 according to the exemplary embodiment of the present invention includes the first electrode structure 110 including the first current collector 112 and the first active material layer 114 and being used as the positive electrode, the first current collector having the ultra-fine rugged structure 112a and the first active material layer 114 containing lithium conformally covering the rugged structure 112a, the second electrode structure 120 being used as the negative electrode, and the solid electrolyte 130, thereby making it possible to have a structure in which the valid contact area between the positive electrode and the solid electrolytes 130 is increased. Therefore, the energy storage apparatus according to the present invention increases the actual reaction area between the first electrode structure 110 and the solid electrolyte 130 and forms the first active material layer 114 containing lithium on the positive electrode, thereby making it possible to significantly improve capacitance.

In addition, the energy storage apparatus 100 according to the exemplary embodiment of the present invention may have a supercapacitor structure using the electrolyte 130 in a solid state. Therefore, the energy storage apparatus according to the present invention may have a structure in which the electrolyte is neither leaked nor corroded and a separator is not required, as compared to an energy storage apparatus using an electrolyte in a liquid state.

Continuously, a method for manufacturing an energy storage apparatus according to an exemplary embodiment of the present invention will be described in detail. Herein, a description overlapping the energy storage apparatus 100 according to an exemplary embodiment of the present invention described above may be omitted or simplified.

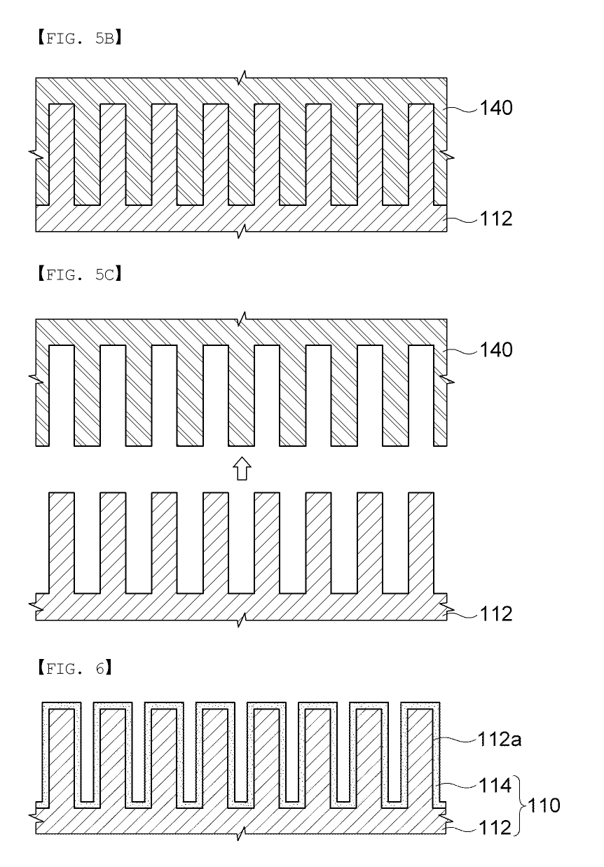

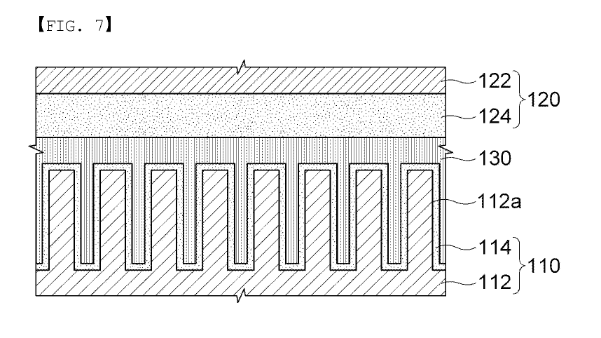

FIG. 4 is a flow chart showing a method for manufacturing an energy storage apparatus according to an exemplary embodiment of the present invention. FIGS. 5 to 7 are diagrams for explaining a method for manufacturing an energy storage apparatus according to an exemplary embodiment of the present invention.

Referring to FIGS. 4 and 5, a first current collector 112 having a rugged structure 112a may be manufactured (S110). First, as shown in FIG. 3A, a nano frame 140 may be prepared. The nano frame 140 may be a base plate for forming a predetermined nanowire or a nanoprojection. As an example, a nanotemplate made of anodic aluminum oxide (AAO) material may be used as the nano frame 140. As another example, a nanotemplate made of an inorganic material may be used as the nano frame 140. As still another example, a nanotemplate made of a polymer material may be used as the nano frame 140.

A metal layer 111 may be deposited on the nano frame 140. The metal layer 111 may be a copper layer. Alternatively, the metal layer 111 may be an aluminum layer. The depositing the metal layer 111 may be performed by performing a predetermined deposition process on the nano frame 140. As the deposition process, various kinds of processes, such as a physical vapor deposition (PVD) process or a chemical vapor deposition (CVD) process may be used. As an example, an electron beam evaporation process may be used as the deposition process.

The metal layer 111 may be separate from the nano frame 140. Therefore, a first current collector 112 having a rugged structure 112a may be manufactured. Herein, the rugged structure 112a may have a line or projection shape having a width size of a nano unit. In this case, the rugged structure 112a has a ultra-fine rugged structure, such that the first current collector 112 with a remarkably increased surface area may be manufactured.

Referring to FIGS. 4 and 6, a first active material layer 114 is formed on the surface of the rugged structure 112a of the first current collector 112, such that a first electrode structure 110 may be manufactured (S120). The forming the first active material layer 114 may be made by performing a predetermined deposition process on the first current collector 112. As the deposition process, various kinds of processes, such as a physical vapor deposition (PVD) process or a chemical vapor deposition (CVD) process may be used. For example, any one of a sputtering method, an E-beam evaporation method, a thermal evaporation method, a laser molecular beam epitaxy (L-MBE) method, and a pulsed laser deposition (PLD) method may be used as the deposition process.

Herein, the forming the first active material layer 114 may be made by forming a lithium containing layer conformally covering the surface of the rugged structure 112a on the first current collector 112. Therefore, the first electrode structure 110 formed with the first active material layer 114 may be manufactured, wherein the first active material layer 114 covers the rugged structure 112a at a uniform thickness.

Referring to FIGS. 4 and 7, a second electrode structure 120 may be formed by forming a second active material layer 124 on a second current collector 122 (S130). First, a predetermined metal foil may be prepared in order to manufacture the second current collector 122. An aluminum foil may be used as the metal foil. Then, the second active material layer 124 may be formed on the metal foil. The second active material layer 124 may be formed by applying slurry including an active material, a conductive material, a binder, or the like, to the metal foil.

Various kinds of carbon materials may be used as the active material. For example, at least any one of activated carbon, graphite, carbon aerogel, polyacrylonitrile (PAN), carbon nano fiber (CNF), activating carbon nano fiber (ACNF), and vapor grown carbon fiber (VGCF) may be used as the active material. For example, activated carbon may be used as the active material. Various kinds of conductive powders may be used as conductive material. For example, at least any one of carbon black, ketjen black, carbon nano tube, and grapheme may be used as the conductive material. For example, carbon black may be used as the conductive material.

The first electrode structure 110 and the second electrode structure 120 may be bonded to each other by interposing a solid electrolyte 130 therebetween (S140). A lithium-based electrolyte in a solid state may be used as the solid electrolyte 130. As an example, the solid electrolyte 130 may be formed by depositing a solid electrolyte on the first active material layer 114 of the first electrode structure 110. The depositing the solid electrolyte 130 may be made by performing various kinds processes, such as a physical vapor deposition (PVD) process or a chemical vapor deposition (CVD) process.

Then, the second electrode structure 120 may be bonded on the first electrode structure 110 formed with the solid electrolyte 130. Therefore, the energy storage apparatus 100 may be manufactured, wherein the first electrode structure 110 and the second electrode structure 120 are bonded to each other by interposing the solid electrolyte 130 therebetween. Herein, the first electrode structure 110 may be a positive electrode of the energy storage apparatus 100 and the second electrode structure 120 may be a negative electrode of the energy storage apparatus 100. Therefore, the energy storage apparatus 100 may be used as a lithium ion capacitor (LIC) which includes the negative electrode and the positive electrode, having a predetermined carbon material as the active material, and uses lithium ions (Li⁺) as carrier ions, which are mediators of an electrochemical reaction.

As described above, the method for manufacturing the energy storage apparatus according to the exemplary embodiment of the present embodiment can manufacture the energy storage apparatus which includes the first electrode structure 110 having the ultra-fine rugged structure 112a to have the increased contact area with the solid electrolyte 130. Therefore, the method for manufacturing the energy storage apparatus according to the present invention can increase the reaction area between the first electrode structure 110 and the solid electrolyte 130, thereby making it possible to manufacture the energy storage apparatus with the increased capacitance.

In addition, the method for manufacturing the energy storage apparatus according to the exemplary embodiment of the present invention can manufacture the energy storage apparatus using the solid electrolyte 130. Therefore, the energy storage apparatus according to the present invention can manufacture the energy storage apparatus in which an electrolyte is neither leaked nor corroded and a separator is not required, as compared to an energy storage apparatus using an electrolyte in a liquid state.

The energy storage apparatus according to the present invention includes the first electrode structure used as a positive electrode and having a rugged structure, the second electrode structure used as a negative electrode, and the solid electrolyte, thereby making it possible to have a structure in which a valid contact area between the positive electrode and the solid electrolyte is increased. Therefore, the energy storage apparatus according to the present invention increases the reaction area between the positive electrode and the solid electrolyte, thereby making it possible to improve capacitance.

In addition, the energy storage apparatus according to the exemplary embodiment of the present invention has the supercapacitor structure in which an electrolyte in a solid state is used, such that the electrolyte is neither leaked nor corroded and a separator is not required, as compared to an energy storage apparatus using an electrolyte in a liquid state.

The method for manufacturing an energy storage apparatus according to the present invention manufactures the first electrode structure having a ultra-fine rugged structure to use it as a positive electrode of the energy storage apparatus, and bonds the first electrode structure to the second electrode structure by interposing the solid electrolyte therebetween, thereby making it possible to manufacture the energy storage apparatus. Therefore, the method for manufacturing the energy storage apparatus according to the present invention can increase the reaction area between the positive electrode and the solid electrolyte, thereby making it possible to manufacture the energy storage apparatus with increased capacitance.

In addition, the method for manufacturing the energy storage apparatus according to the exemplary embodiment of the present invention can manufacture the energy storage apparatus with a supercapacitor structure using the solid electrolyte. Therefore, the method for manufacturing an energy storage apparatus according to the present invention can manufacture the energy storage apparatus in which an electrolyte is neither leaked nor corroded and a separator is not required, as compared to an energy storage apparatus using an electrolyte in a liquid state.

The present invention has been described in connection with what is presently considered to be practical exemplary embodiments. Although the exemplary embodiments of the present invention have been described, the present invention may be also used in various other combinations, modifications and environments. In other words, the present invention may be changed or modified within the range of concept of the invention disclosed in the specification, the range equivalent to the disclosure and/or the range of the technology or knowledge in the field to which the present invention pertains. The exemplary embodiments described above have been provided to explain the best state in carrying out the present invention. Therefore, they may be carried out in other states known to the field to which the present invention pertains in using other inventions such as the present invention and also be modified in various forms required in specific application fields and usages of the invention. Therefore, it is to be understood that the invention is not limited to the disclosed embodiments. It is to be understood that other embodiments are also included within the spirit and scope of the appended claims.

What is claimed is:

1. An energy storage apparatus, comprising:
a first electrode structure;
a second electrode structure opposite to the first electrode structure; and
an electrolyte positioned between the first electrode structure and the second electrode structure,
wherein the first electrode structure includes:
a first current collector having a rugged structure; and
a first active material layer conformally covering the rugged structure.

2. The energy storage apparatus according to claim 1, wherein the first current collector includes a metal plate made of copper.

3. The energy storage apparatus according to claim 1, wherein the first active material layer includes a lithium containing metal layer.

4. The energy storage apparatus according to claim 1, wherein the second electrode structure includes:
a second current collector; and
a second active material layer formed on the second current collector,
the second current collector including an aluminum foil, and
the second active material layer including at least any one of activated carbon, graphite, carbon aerogel, polyacrylonitrile (PAN), carbon nano fiber (CNF), activating carbon nano fiber (ACNF), and vapor grown carbon fiber (VGCF).

5. The energy storage apparatus according to claim 1, wherein the electrolyte is provided in a solid state.

6. The energy storage apparatus according to claim 1, wherein the electrolyte includes at least any one of LiPF6, LiBF4, LiSbF6, LiAsF5, LiClO4, LiN, CF3SO3, LiC, LiN(SO2CF3)2, LiN(SO2C2F5)2, LiC(SO2CF3) 2, LiPF4(CF3)2, LiPF3(C2F5)3, LiPF3(CF3)3, LiPF5(iso-C3F7)3, LiPF5(iso-C3F7), (CF2)2(SO2)2NLi, and (CF2)3(SO2)2NLi.

7. The energy storage apparatus according to claim 1, wherein the rugged structure includes at least any one of pillar-shaped projections and line-shaped trenches.

8. The energy storage apparatus according to claim 1, wherein the first electrode structure is a positive electrode of the energy storage apparatus,
the second electrode structure is an negative electrode of the energy storage apparatus, and
the electrolyte includes lithium ions (Li⁺) for a charging reaction mechanism between the positive electrode and the negative electrode.

9. A method for manufacturing an energy storage apparatus, comprising:
preparing a first current collector having a rugged structure;
forming a first active material layer conformally covering the rugged structure to manufacture a first electrode structure;
forming a second active material layer on a second current collector to manufacture a second electrode structure; and
forming an electrolyte between the first electrode structure and the second electrode structure.

10. The method for manufacturing an energy storage apparatus according to claim 9, wherein the preparing the first current collector includes:
preparing a metal frame formed with a ruggedness with a shape corresponding to the rugged structure;
depositing a metal layer on the ruggedness of the metal frame; and
separating the metal layer from the metal frame.

11. The method for manufacturing an energy storage apparatus according to claim 10, wherein the depositing the metal layer includes forming an aluminum layer on the metal frame.

12. The method for manufacturing an energy storage apparatus according to claim 10, wherein the depositing the metal layer includes performing a physical vapor deposition (PVD) on the metal frame.

13. The method for manufacturing an energy storage apparatus according to claim 9, wherein the forming the first active material layer includes depositing a lithium containing metal layer on the rugged structure.

14. The method for manufacturing an energy storage apparatus according to claim 9, wherein an aluminum foil is used as the second current collector, and the second active material layer includes an active material made of a carbon material.

15. The method for manufacturing an energy storage apparatus according to claim 14, wherein at least any one of activated carbon, graphite, carbon aerogel, polyacrylonitrile (PAN), carbon nano fiber (CNF), activating carbon nano fiber (ACNF), and vapor grown carbon fiber (VGCF) is used as the carbon material.

16. The method for manufacturing an energy storage apparatus according to claim 9, wherein the first electrode structure is used as a positive electrode of the energy storage apparatus, and the second electrode structure is used as a negative electrode of the energy storage apparatus.

17. The method for manufacturing an energy storage apparatus according to claim 9, wherein the forming the electrolyte includes depositing an electrolyte in a solid state on at least any one of the first electrode structure and the second electrode structure.

18. The method for manufacturing an energy storage apparatus according to claim 9, wherein the first active material layer contains lithium, the electrolyte includes at least any one of LiPF6, LiBF4, LiSbF6, LiAsF5, LiClO4, LiN, CF3SO3, LiC, LiN(SO2CF3)2, LiN(SO2C2F5)2, LiC(SO2CF3)2, LiPF4 (CF3)2, LiPF3(C2F5)3, LiPF3(CF3)3, LiPF5(iso-C3F7)3, LiPF5(iso-C3F7), (CF2)2(SO2)2NLi, and (CF2)3(SO2)2NLi, and the energy storage apparatus is used as a lithium ion capacitor (LIC) using lithium ions (Li⁺) as carrier ions for a charging/discharging reaction mechanism.
